(19) United States
(12) Patent Application Publication
(10) Pub. No.: US 2006/0081651 A1
(43) Pub. Date: Apr. 20, 2006

(54) Flame free essential oil emitter

(76) Inventor: Pei-Fang Lee, Kaohsiung City (TW)

Correspondence Address: LEONG C LEI, PMB # 1008, 1867 YGNACIO VALLEY ROAD, WALNUT CREEK, CA, 94598, US

(21) Appl. No.: 10/964,678

(22) Filed: Oct. 15, 2004

(51) Int. Cl. B67D 3/00

(52) U.S. Cl. 222/187

(57) ABSTRACT

A flame free essential oil emitter comprised of a cord, a cord head, a bottle and a sleeve; a shallow disk having a central hole provided at the bottom of a cord head; the sleeve with an external groove packed with a washer inserted through the central hole; multiple claws in the central opening to secure a cord; the cord head being stuffed into the opening of the bottle through the sleeve; the wash holding against the inner wall of the bottleneck to prevent leakage of the essential oil.

### BACKGROUND OF THE INVENTION

(a) Technical Field of the Invention

The present invention is related to a flame free essential oil emitter, and more particularly to a closed bottle in simplified construction that prevents leak of essential oil.

(b) Description of the Prior Art

Increased personal income permits improved living quality. To fend off the work pressure from living in a highly competitive society, people have to find ways to get refreshed and ready for meeting future challenges.

Staying at home with the beloved after work, listening to the music, and many other ways would help ease off the stress depending on individual taste. The introduction of the essential oil is an effective way to relax. The cord of the essential oil bottle must be ignited to emit the essential oil into the atmosphere. To achieve the purpose, alcohol is added into the essential oil and thus exposed the user to the danger of getting burnt or even causing a fire alarm if the essential oil bottle tilts over by accident. Therefore, a flame free essential oil emitter of the prior art is introduced to eliminate the exposure to fire. As illustrated in FIGS. 1, 2, and 3 of the accompanying drawings, the prior art is essentially comprised of a bottle 1, a cord head 2, a ring cap 3 and a retainer ring 4. Wherein, the bottle is hollow and extends from its top a bottleneck 11 and an opening 12. A recess 21 is provided at the bottom of the cord head 2 and a through hole is disposed at the center of the recess 21. The bottom of the ring cap 3 is open provided on its inner wall multiple threads 31 and the upper surface of the ring cap 3 is disposed with a hole 32 in relation to another hole 22 provided in the cord head 2. The ring cap 3 is stuffed and secured in position in the recess 21 and a cord 23 passes through the hole 32 of the ring cap 3 before being held in position in the hole 22 of the cord head. The retainer ring 4 is screwed to the bottleneck 11 and an opening 41 is provided on the top surface of the retainer ring 4 to prevent from screening the bottle opening 12 while allowing the cord 23 to reach down into the bottle 1 through the opening 41 and the bottle opening 12. Multiple threads 42 are provided on the outer surface of the retainer ring 4 for the cord head 2 to screw to the retainer ring 4 using the ring cap 3 stiffed in the recess 21 to become the essential oil emitter. With the essential oil filled up in the bottle 1, the essential oil is conducted to the cord head 2 through the cord 23. The cord head gets moisture by the essential oil due to that the cord head made of ceramic material so to release fragrance into the atmosphere. Furthermore, no alcohol is added into the bottle to dilute the essential oil, the essential oil evaporate slower to give it longer service life. The design of the threaded ring cap 3 and retainer ring 4 keeps the bottle in closed status when the bottle 1 is incorporated to the cord head 2 to prevent unnecessary evaporation of the essential oil. In case of the bottle 1 tilts over, the essential oil will not flow out of the bottle. However, the screwed ring cap 3 and the retainer ring 4 results in more elements required, thus higher production cost.

### SUMMARY OF THE INVENTION

The primary purpose of the present invention is to provide a flame free essential oil emitter that allows simplified construction and cost reduction while preventing leakage of the essential oil. To achieve the purpose, the present invention is comprised of a bottle, a cord head, and a cord. Wherein, a shallow disk having a central hole provided at the bottom of a cord head; a sleeve penetrating into the emitter through the central hole has provided on its outer side a groove to be stuffed with a soft washer; multiple claws are provided on the central opening of the sleeve with a cord penetrating through and held in position; the cord head is inserted into the bottle from its opening through the sleeve to tightly hold against the inner wall of the bottleneck for the opening to stay in a closed status.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a flame free essential oil emitter of the prior art.

FIG. 2 is a sectional view of the prior art as assemble.

FIG. 3 is a perspective view of the prior art.

FIG. 4 is an exploded view of a preferred embodiment of the present invention.

FIG. 5 is a sectional view of the preferred embodiment of the present invention as assembled.

FIG. 6 is a perspective view of the preferred embodiment of the present invention.

FIG. 7 is an exploded view of another preferred embodiment of the present invention.

FIG. 8 is a sectional view of another preferred embodiment of the present invention as assembled.

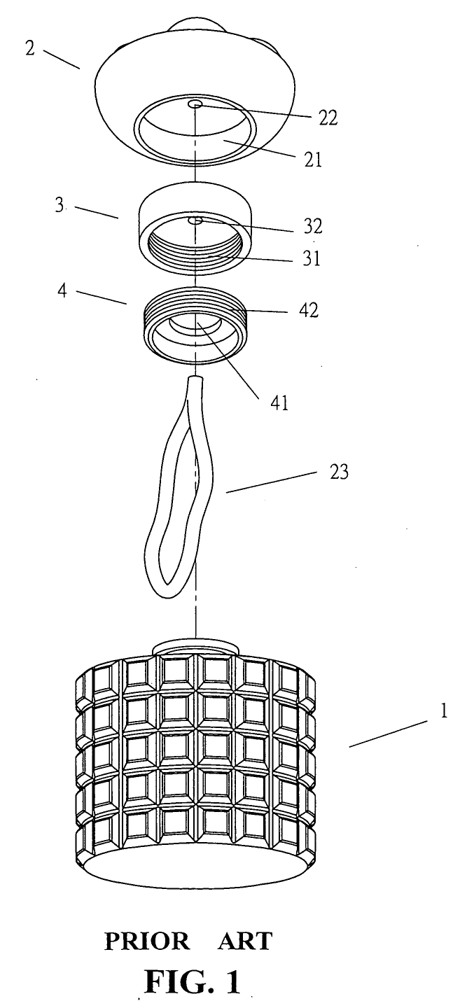

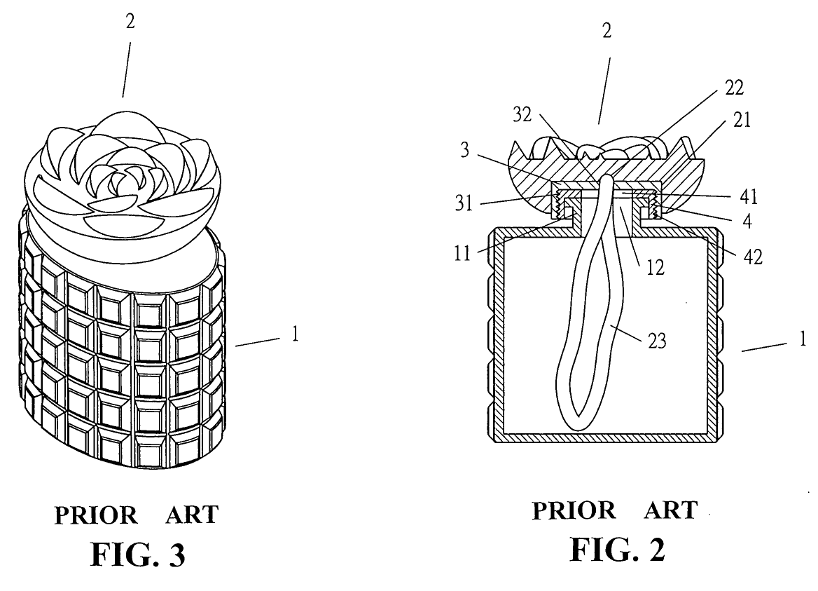

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

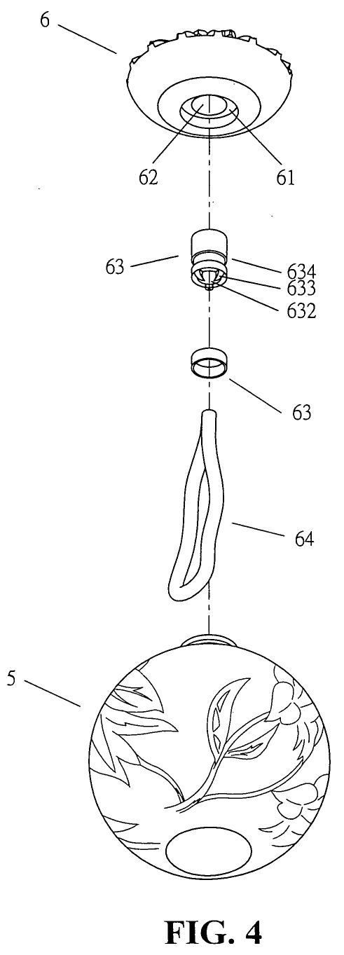

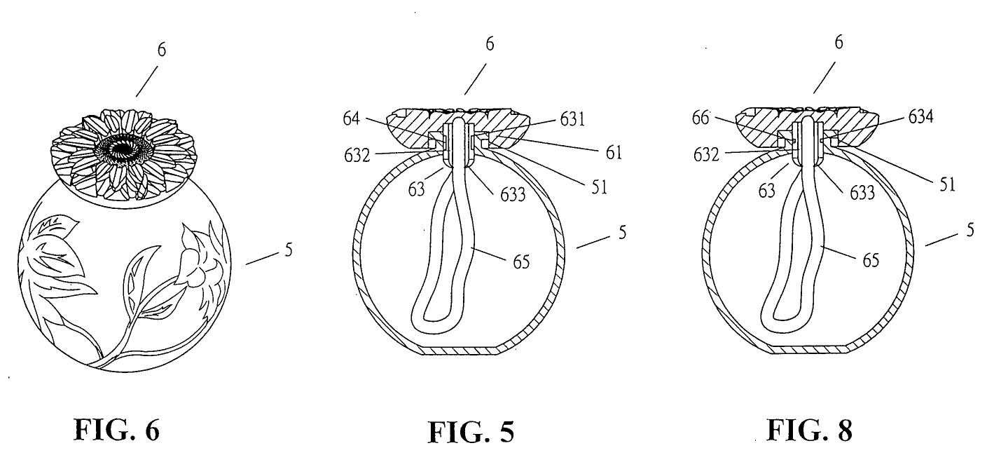

Referring to FIGS. 4 and 5, the present invention is essentially comprised of a bottle 5 and a cord head 6. As illustrated in FIG. 6, the cord head 6 made of ceramic material is stuffed to and secured at the top of the bottle 5. Wherein, a shallow disk 61 is provided at the bottom of the cord head 6 and a hole 62 is provided at the center of the shallow disk 61 to receive insertion of and hold in position a sleeve 63 provided on its outer surface a groove 631. The groove 631 is stuffed with a soft washer 64, and multiple claws 633 at a given spacing are provided on a central opening 632 in the sleeve 631. Upon penetrating through the central opening 632, a cord 64 is secured by those claws 633. The inner diameter of a bottleneck 51 of the bottle 5 is equal to the outer diameter of the sleeve 63 so for the bottleneck 51 to merely receive insertion by the sleeve 63.

In use, the essential oil is filled into the bottle 5, and then the cord head 6 is stuffed into the bottleneck 51 of the bottle 5 for the top of the bottleneck 51 to hold against the upper wall of the shallow disk 61 of the cord head 6 to complete the assembly of the emitter. The essential oil emits into the atmosphere from the cord head 6 conducted through the cord 65. Whereas the washer 64 is packed in the groove 631 externally to the sleeve 63, the washer 64 tightly holds against the inner wall of the bottleneck to firmly close up the opening of the bottle 5 when the sleeve 63 is inserted into the opening of the bottle 5 to prevent leakage or unnecessary evaporation of the essential oil.

The construction of the present invention is not only simple by having only providing the sleeve 63 packed with the washer 64 stuffed to the shallow disk 61 at the bottom of the cord head 6 to be incorporated to the bottle 5, but also effectively reduce production cost by reducing the number of the elements. Meanwhile, the incorporation of the bottle 5 and the cord head 6 in the present invention allows easy refill of the essential oil simply by removing the cord head.

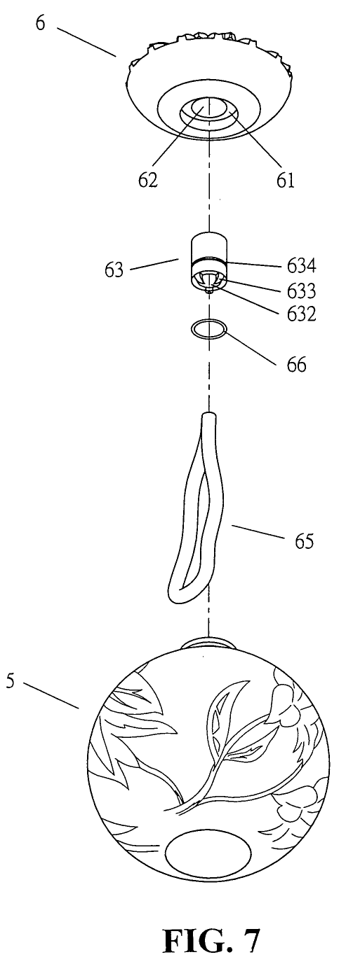

Furthermore, as illustrated in FIGS. 7 and 8, a minute shallow disk 634 is provided to the exterior of the sleeve 63 to receive of an O-ring 66 in position. Accordingly, when the cord head 6 is secured in the bottle 5 by means of the sleeve 63, the O-ring 66 holds against the inner wall of the bottleneck 51 of the bottle to keep the opening of the bottle 5 in closed status to achieve the same purpose of preventing the essential oil in the bottle 5 to leak or evaporate.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A flame free essential oil emitter essentially comprised of a bottle and a cord head; a bottleneck with an opening provided on the top of the bottle; the cord head being stuffed and secured in position in the bottleneck; a cord extending into the bottle; a shallow disk with a central hole being disposed at the center of the cord head; the central hole holding the sleeve in place; a groove being provided to the outer surface of the sleeve and packed with a soft washer; multiple claws being provided at the central opening of the sleeve at a given spacing from one another, the cord being secured by those claws; and the inner diameter of the bottle opening being equal to the outer diameter of the sleeve to hold the sleeve in position.

2. A flame free essential oil emitter essentially comprised of a bottle and a cord head; a bottleneck with an opening provided on the top of the bottle; the cord head being stuffed and secured in position in the bottleneck; a cord extending into the bottle; a shallow disk with a central hole being disposed at the center of the cord head; the central hole holding the sleeve in place; a groove being provided to the outer surface of the sleeve and packed with a soft washer; an O-ring being inserted into the groove; multiple claws being provided at the central opening of the sleeve at a given spacing from one another; the cord being secured by those claws; and the inner diameter of the bottle opening being equal to the outer diameter of the sleeve to hold the sleeve in position.
